(19) United States
(12) Patent Application Publication
(10) Pub. No.: US 2001/0011362 A1
(43) Pub. Date: Aug. 2, 2001

(54) Semiconductor layout design method and apparatus

(75) Inventor: Hiroko Yoshinaga, Kanagawa (JP)

Correspondence Address: FOLEY & LARDNER, Washington Harbour, 3000 K Street, N.W., Suite 500, P.O.Box 25696, Washington, DC, 20007-8696, US

(73) Assignee: NEC CORPORATION

(21) Appl. No.: 09/769,361

(22) Filed: Jan. 26, 2001

(30) Foreign Application Priority Data
Jan. 27, 2000 (JP) 2000-18270

(51) Int. Cl. G06F 17/50

(52) U.S. Cl. 716/8; 716/12

(57) ABSTRACT

According to a semiconductor device design method and apparatus of the present invention, a semiconductor device with homogenous wiring densities throughout the entire layout, and with uniform etching, is provided. In order to facilitate homogenous levels of wiring density and uniform etching within the design of the semiconductor layout after the layout has been configured (S1) using an automated layout system, certain regions of the layout are tested (S2). Once regions of low density have been determined (S3), dummy terminals are formed on power and ground lines (S11, S12). These dummy terminals are then interconnected with supplemental wiring (S13 to S16) so that the density of the selected region is brought within a predetermined allowable range.

### BACKGROUND OF THE INVENTION

1. Field of the Invention

The present invention relates to a semiconductor layout design method and apparatus. In particular, it relates to an automated semiconductor layout design method, with which it is easier to homogenize the wiring density within circuitry; as well as the apparatus which executes the method.

2. Description of the Related Art

When manufacturing semiconductors, there are usually problems that arise with pattern structures used in the manufacturing process. Namely, when there are variations in density distribution, problems develop where etching has not been performed evenly. Also, when the density of wiring decreases in certain regions of the layout, portions between wirings that are not etched are left behind, which can increase the possibility of short circuits occurring in the circuitry, since the area that needs to be etched when forming circuitry increases. In order to resolve the cause of these problems, the following two countermeasures have conventionally been provided.

The first countermeasure consists of configuring a dummy cell in order to facilitate setting the wiring density to its optimum value, for example as shown in the first conventional example of Japanese Patent application Laid-open Hei 11-176941. The method shown in this first conventional example is shown in FIGS. 1A and 1B.

FIG. 1A is a layout diagram of a configured functional block showing the portion where the surface area occupied by functional block 20 is relatively small. In this case, since the density of wiring connecting functional block 20 is relatively low, the wiring density is lower than the predetermined range. Therefore, by configuring dummy cell 22 with wiring data in the open space, as in the layout diagram in FIG. 1B, the density can be brought to be within the predetermined range.

However, in this first countermeasure, the density can be equalized for only the amount of wiring in the open space. Also, because the dummy cell is configured in the open space, there is less space available to use for interconnects.

The second countermeasure consists of configuring dummy wiring in order to facilitate setting the wiring density to its optimum value, for example as shown in Japanese Patent Application Laid-open Hei 9-293721.

This second countermeasure will be described while referencing FIGS. 2A and 2B. FIG. 2A is a layout diagram before the formation of dummy wiring, where the wiring density is lower than the predetermined range. Once layout design has been performed as shown in the layout diagram of FIG. 2B, the resulting wiring density is determined. If the wiring density is too low, then dummy wiring 32 is set up in the entire layout region (including the dummy wiring that had already been formed to begin with) and the portion of dummy wiring 32 that has overlapped the functional lines 31, or the excessive parts of the dummy wiring 32 is removed. Thereafter, via holes and contact holes are opened, leaving behind an amount of conductive material within the selected surface region that is equal to the predetermined amount.

However, with these techniques, since dummy wiring 32 is left in an electrically floating state, the capacity of the adjacent wiring can vary from its expected value and the possibility of noise interference increases.

Furthermore, there are techniques familiar to those skilled in the art that fill the entire open space with dummy wiring; however, even though these techniques may have uniform wiring density, there is little freedom allowed in setting wiring density. Therefore problems develop during the etching processes while forming wiring, such as over-etching, even when the wiring density is already too high.

### SUMMARY OF THE INVENTION

The objective of the present invention is to provide an automated layout apparatus and method for an automated semiconductor device layout system, which allows for homogenous wiring density throughout the entire layout and uniformity in semiconductor manufacturing processes such as etching.

According to an aspect of the present invention, a semiconductor layout design method of designing semiconductor layouts with homogenous levels of wiring density is provided. This method is comprised of the step of configuring a plurality of dummy terminals (D1, D2, . . . ) on at least one power line (S11) in order to adjust wiring density. An example of this is illustrated in FIG. 3.

Said semiconductor layout design method is further comprised of the step of configuring at least one wire that connects one of said plurality of dummy terminals on part of said power line to an other one of said plurality of dummy terminals on a distant part of said power line to adjust wiring density (S16).

According to an aspect of the present invention, an apparatus for designing semiconductor layouts with homogenous levels of wiring density is comprised of a configurating means that configures a plurality of dummy terminals (D1, D2, . . . ) on at least one power line to adjust wiring density. This apparatus is further comprised of a second configurating means that configures at least one wire connecting one of said plurality of dummy terminals on part of said power line to another one of said plurality of dummy terminals on a distant part of said power line in order to adjust wiring density. This apparatus can be obtained by implementing a computer program representing the procedure in FIG. 3 using computer hardware shown in FIG. 9.

### BRIEF DESCRIPTION OF DRAWINGS

The above and other objects, features and advantages of the present invention will become more apparent from the following detailed description, when taken in conjunction with the accompanying drawings, wherein:

FIGS. 1A and 1B are layout diagrams describing the configuration of a conventional example of a dummy cell;

FIGS. 2A and 2B show the configuration of a conventional example of dummy wiring;

FIG. 3 is a flowchart describing a first embodiment of the present invention;

FIGS. 4A to 4C are layout diagrams describing the steps forming the layout of a semiconductor device according to the first embodiment of the present invention;

FIGS. 5A and 5B are layout diagrams describing the continuation of the steps shown in FIG. 4C;

FIG. 6 is a schematic diagram showing the structure of a dummy terminal appropriate for the semiconductor device described in FIG. 4B;

FIGS. 7A and 7B are layout diagrams describing the configuration of dummy terminals according to a second embodiment of the present invention; and

FIGS. 8A and 8B are layout diagrams describing the configuration of supplemental wiring of dummy terminals according to a third embodiment of the present invention.

FIG. 9 is a schematic diagram illustrating an example of a computer system that executes a computer-program corresponding to the procedure shown in the flowchart of FIG. 3.

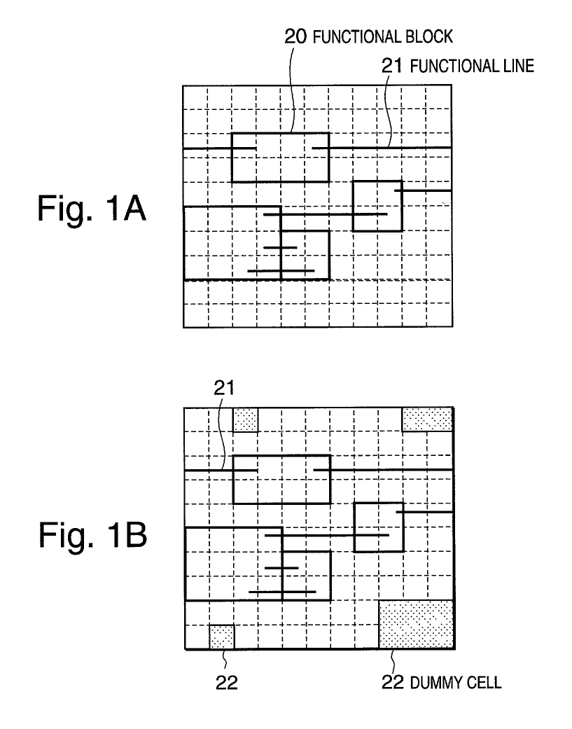

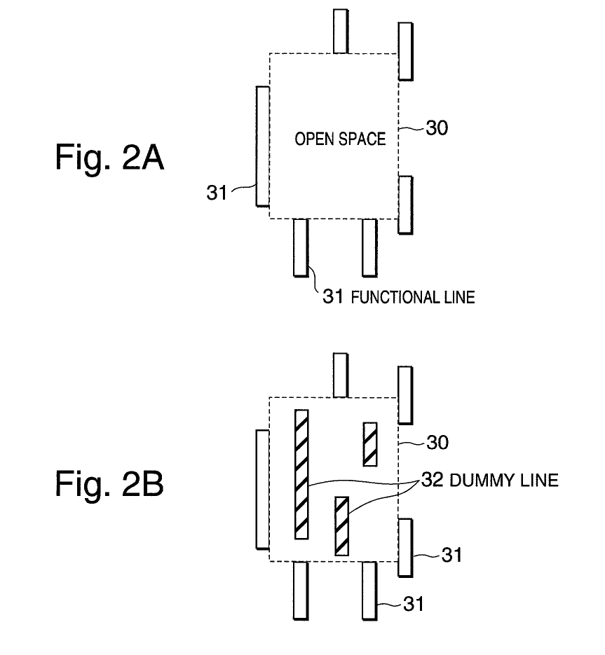

### DETAILED DESCRIPTION OF THE PREFERRED EMBODIMENTS

(First Embodiment)

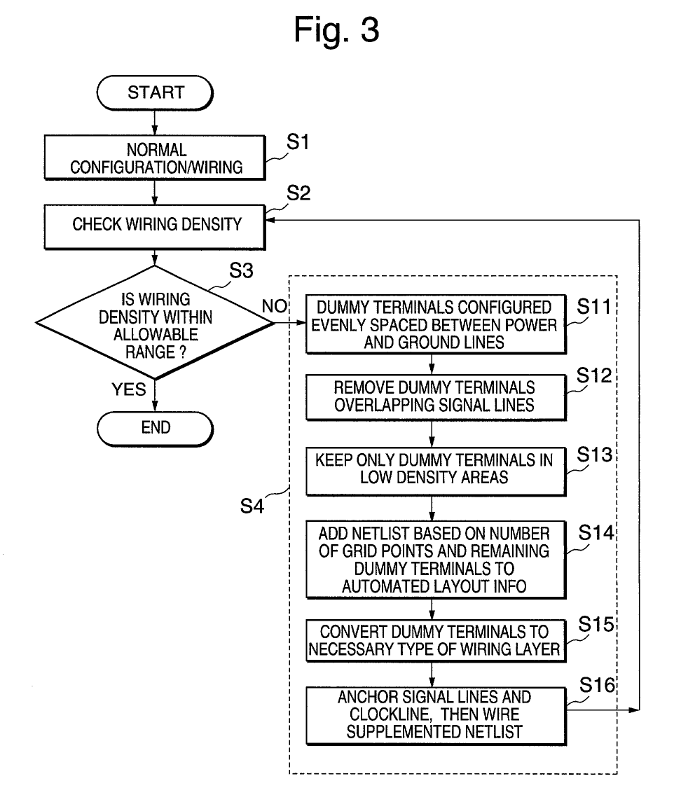

The embodiment of the present invention will now be described while referencing the flowchart in FIG. 3. The present embodiment begins with Step S1, the configuration of the functional block and the placement of signal wires using automated layout; and Step S2, checking the wiring density. If the wiring density is lower than the minimum allowable range (for example 20% or higher) during Step S3, then it is subjected to the processes of Step S4.

Step S4 is comprised of steps S11 through S16. At step S1, dummy terminals are arranged at even intervals above the power and/or ground lines such that the dummy terminals are electrically connected to these lines. At step S12, those dummy terminals overlapping the signal lines are removed. At step S13, only dummy terminals in those areas where the density is low are left intact. At step S14, a supplemental netlist is added to the netlist used with the normal wiring configuration, wherein the supplemental netlist (connection information for the relative or fixed coordinates that will be wired by the automated layout system) is the netlist compiled using CAD (computer-aided design) tools, which calculate the number of wiring grids in the open space and the number of wires that need to be added based on the number of dummy terminals left intact in Step S13. At step S15, those remaining dummy terminals remaining throughout the netlist are converted into arbitrary wiring layers or via layers used to connect between arbitrary wiring layers or wires. At step S16, the relative coordinates of the original signal lines are changed into fixed coordinates and the routes of the original signal lines are determined according to the resulting fixed coordinates using the automated layout system. Thereafter, the routes of dummy terminals left within the open space, which have been connected to the power and/or ground lines, are determined using the said automated layout system. As a result, the optimum value of wiring density can be reached.

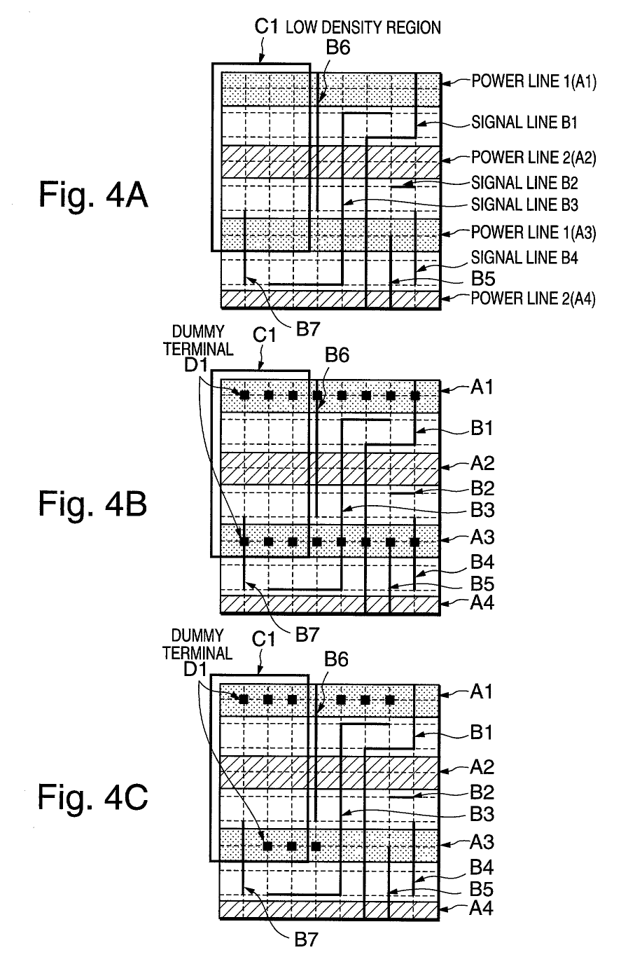

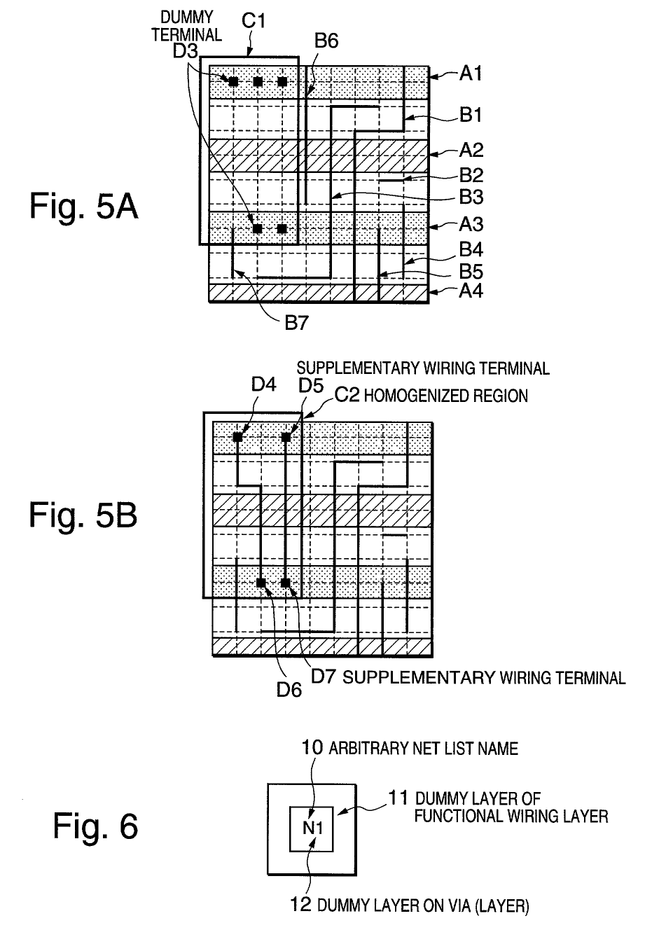

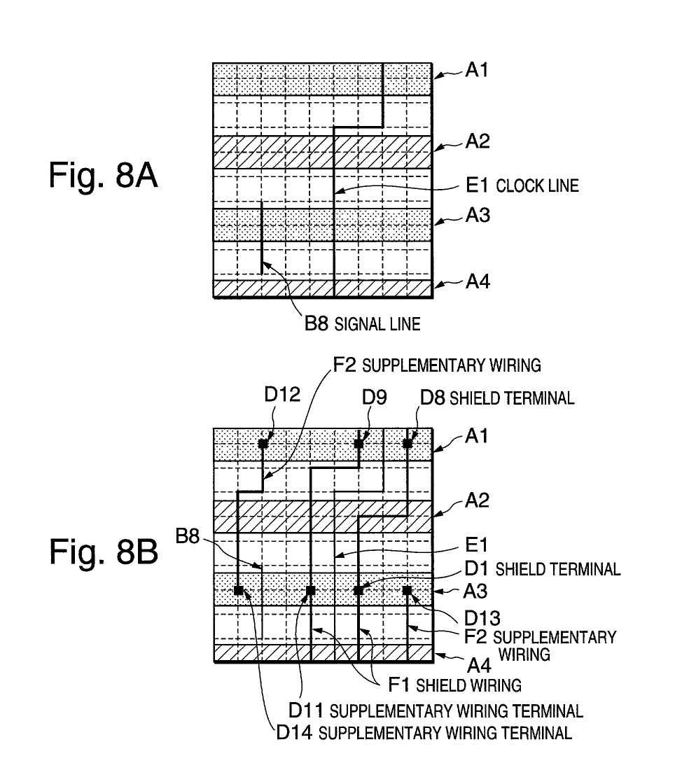

An example of a detailed layout resulting from executing the process as shown in FIG. 3 when a certain wiring density is not obtained will be described while referencing the layout diagrams in FIGS. 4A to 5B. Segments A1 to A4 of power lines 1 and 2, and segments B1 to B7 of signal line are formed from their certain respective wiring layers. Here it is assumed that power lines 1 and 2 (A1 to A4) are formed from a certain first metal layer (metal 1) and the signal lines (B1 to B7) are formed from a certain second metal layer (metal 2). Furthermore, the clock lines and shield wiring lines (see FIGS. 8A and 8B) are also formed from the same metal 2.

As shown in FIG. 4A, if there exists a certain region Cl with low wiring density after signal lines B1 to B7 have been formed, then dummy terminals D1 are placed at even intervals on power lines 1 (A1 and A3), as shown in FIG. 4B. These dummy terminals D1 are comprised of a dummy layer 11 appropriate for the functional wiring layer, a dummy layer 12 appropriate for the via hole used to connect it, and an arbitrary terminal name 10, as shown in FIG. 6.

Next as shown in FIG. 4C, the dummy terminals D1 overlapping the wirings of signal lines B1 to B7 are removed. Then as shown in FIG. 5A, the rest of the dummy terminals, except for those within the low-density region C1, are removed. This process allows for the placement of dummy terminals D3 in order to facilitate the usage of supplementary wiring.

Next, calculation is performed to determine the necessary number of grid points to satisfy a certain desired wiring density or a minimum allowable range, e.g., 20% or higher. The relationship between the wiring grid and the wiring density will now be explained. Because the wiring grid is dependent on the width of the individual wires (wire width) and the gaps between wires (wire gap), the wiring density is determined in the manner shown in the following paragraph. Furthermore, since the wiring grid denotes specific points, with which each address of an element on a semiconductor substrate is designated, two coordinates, or the start and end coordinates of each wiring are required to decide its physical location and to determine its route.

The wiring density between the two adjacent points on the wiring grid is denoted by x as a percentage, and the wiring density for the selected portion of wiring grid is denoted by y as a percentage. These are determined by the following equations:

x=wire width/(wire width+wire gap)×100 (%)

y=[(functional wiring grid−1)×(number of wires/total wiring grid)]×100 (%)

where the wire width and wire gap are assumed to be equal. Also, points are denoted in the wiring grids shown in FIGS. 4A to 5B at the intersections of two lines.

For example in FIG. 4A, open space C1 has 21 points of wiring grid, and of those, 2 points are functional wiring; therefore, it can be said that the wiring density in open space C1 is approximately 5%, which falls short of the minimum allowable range of 20%. In order to reach this allowable range of 20%, it is necessary to add 10 points of supplemental wiring to the wiring grid. Since there are 6 points between dummy terminals D5 to D7, two supplemental wires need to be added. The result of the above calculation and the netlist for the supplementary wiring from the terminals of the functional supplemental wiring are added to the automated layout information, which is formed, for example, using CAD tools.

Next, the dummy wiring layers and via layers of dummy terminals are converted into functional wiring layers and functional via layers, and the dummy terminals become supplementary wiring terminals. Based on this net information, it becomes possible to connect dummy terminals D4 and D5 to their partner dummy terminals D6 and D7, respectively, as shown in FIG. 5B; thus creating homogenized region C2.

By following the above process flow, the wiring density in portions of low density is made to be within the minimum allowable range. Therefore, it is possible to perform uniform etching when forming wiring, For example, if the wiring grid has 20 grid points, and of those 5 are functional, then the wiring density for that region is said to be 13%. As a result, it is possible to increase the wiring density of that region to 30% by increasing the number of functional grid points to 10. This is assuming that (based on the relationship of wire width to wire gap) if all 20 grid points are functional, the wiring density is said to be 50%.

As a result of following the above process steps, it is possible to regulate the metal (e.g., aluminum or any other appropriate metal) wiring density to be within the predetermined allowable range because supplemental wiring is performed in each wiring layer for those portions that have a low density of wiring following initial automated wiring configuration.

Incidentally, according to the first embodiment, dummy terminals are arranged evenly spaced on power lines. However, the present invention is not limited to this. Naturally, the dummy terminals can be arranged unevenly spaced on the power lines.

(Second Embodiment)

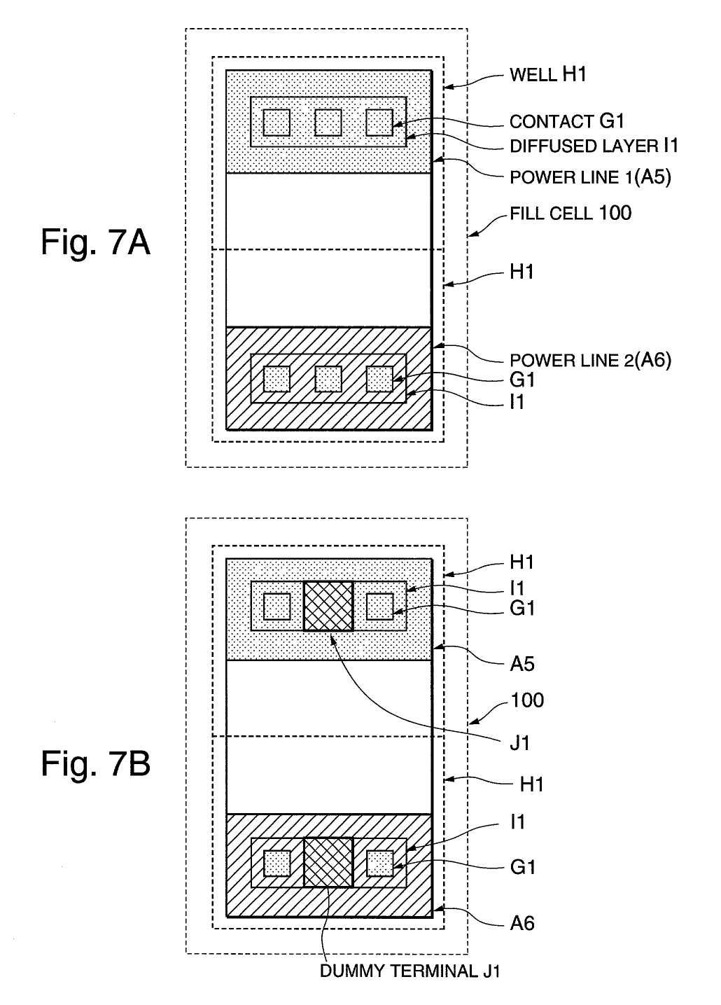

The addition of supplementary wiring through the use of dummy terminals, according to a second embodiment of the present invention, will now be described while referencing the layout diagrams in FIGS. 7A and 7B. The fundamental structure of the present embodiment is the same as the first embodiment; however, it includes an alternate method of configuring the dummy terminals. As shown in FIG. 7A, the automated layout system forms wells Hl within the gap-filling cell (fill cell 100) or within a functional block cell; diffused layers I1 within the respective wells Hl; and at least one contact G1 is formed on top of each diffused layer I1. Within the fill cell 100, power lines 1 and 2 (A5 and A6) are formed covering the respective diffused layers I1. As shown in FIG. 7B, at least one supplemental wiring dummy terminal J1 is formed on top of at least one contact G1 along each of these respective power lines 1 and 2 (A5 and A6). In this manner, the supplemental wiring dummy terminal J1 is prepared in advance.

The supplemental wiring process using dummy terminals within a fill cell 100 will now be described. Once the functional block has been configured using automated layout, and once wiring has been performed, fill cells 100 are created to fill in the gaps. By arranging at least one of the dummy terminal D (see FIG. 6) within these fill cells and functional blocks in advance, it is possible to omit the step of configuring dummy terminals in evenly spaced intervals. Moreover the formation of fill cells 100 facilitates voltage level stabilization along the power lines. Once these dummy terminals have been prepared, they are converted from supplemental wiring dummy terminals into supplemental wiring functional terminals in the same manner as was shown in FIGS. 4A to 5B of the first embodiment. Finally, by performing supplemental wiring using the automated layout system, the wiring density is regulated to be within the minimum allowable range, also in the same manner as the first embodiment.

(Third Embodiment)

An alternate method of removing dummy terminals, according to a third embodiment of the present invention, will now be described while referencing FIGS. 8A and 8B. The same basic configuration as was shown in FIGS. 4A to 5B is used; however, a clock line E1 and an addition signal line B8 have been added, as shown in FIG. 8A. In this case, if the wiring density is lower than the minimum allowable range, dummy terminals are configured using the method described in the first embodiment, and then the excess dummy terminals that overlap signal line B8 and clock signal E1 are removed. At this point in the second embodiment, the number of wiring grid points is calculated for only the open space and the dummy terminals are selected; however in this embodiment, the clock line E1 is identified. As shown in FIG. 8B, the wiring grid points, which lie next to clock line E1, such as dummy terminals D8 to D11, are not removed but left behind as shield wiring terminals D8 to D11, and supplemental wiring is configured connecting the dummy terminals along each side of clock line E1 by having the CAD tool add the netlist to the automated layout information.

Once this is completed, the number of wiring grid points that fall within only the open space is re-calculated and if the wiring density is still lower than the minimum allowable range, then the method in the first embodiment is performed by having the automated layout system situate supplemental wiring on the clock line E1 and add supplemental wiring to the open space. As shown in FIG. 8B, this method results in shield wire F1 for clock line E1 and supplemental wiring in the open space. Furthermore, the dummy terminals D12 to D14 along supplemental wiring F2 become supplemental wiring terminals D12 to D14 and can also be formed from metal 2. The formation of this type of shield wire F1 results in the clock line F1, which is relatively sensitive to noise, being stronger and more resistant to noise interference.

With the structure according to the present invention, and which is described above, since supplemental wiring is added to the areas of low-density wiring layer-by-layer, the aluminum (or any other appropriate metal) wiring density can be controlled to be within the appropriate range. Furthermore, since the supplemental wiring is connected to the power source or ground, it becomes electrically stable wiring; therefore capacitance estimation for the surrounding wiring can be performed without generating errors. Yet even furthermore, as a result of the shield being formed, it is more resistant to noise interference.

[Fourth Embodiment]

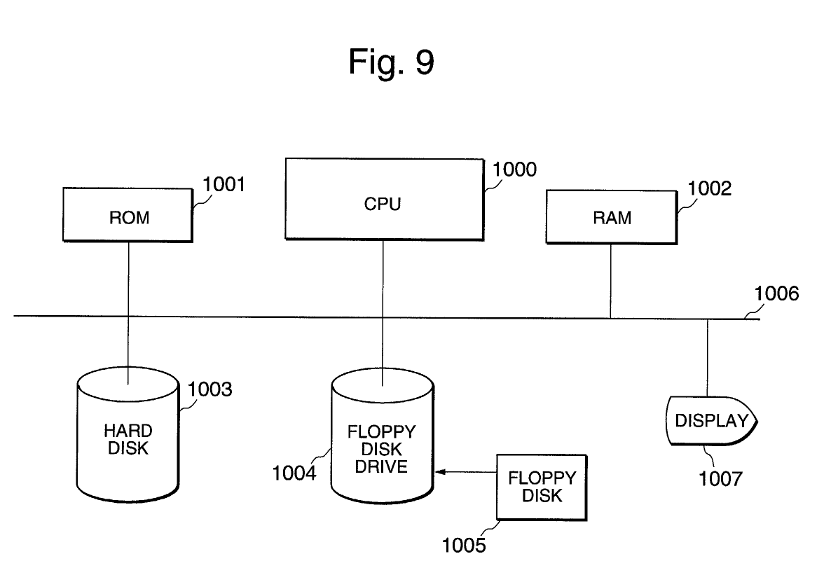

Next, an example of a computer hardware structure, which performs a computer program representing the process shown in the flowchart in FIG. 3, according to the present invention, will be detailed while referencing FIG. 9. In FIG. 9, the computer system is comprised of a CPU 1000, ROM 1001, RAM 1002, hard disk 1003, floppy disk drive 1004, display 1007, communication lines 1006 that communicate commands/data among the above components, and a floppy disk 1005 that is stored with the computer program and interconnect/layout information for the aforementioned semiconductor device, according to the present invention (alternatively, these can be pre-stored in the hard disk 1003 or ROM 1001). The CPU reads out the computer program from, for example, either the ROM 1001, hard disk 1003, or floppy disk 1005, interprets it, and executes accordingly. The RAM is used as a working area, which is stored with, for example, the values of variables defined in the said computer program.

The CPU can be a microprocessor or a micro-sequencer. The present invention has been described as including the said computer program in floppy disk drive 1004, ROM 1001, or hard disk 1003; however it is not limited to this. The computer system can be further comprised of a CDROM drive, MD drive, tape drive or any other appropriate memory device stored with the said computer program.

The semiconductor layout design method and apparatus, according to the present invention, have been described in connection with several preferred embodiments. It is to be understood that the subject matter encompassed by the present invention is not limited to those specified embodiments. On the contrary, it is intended to include as many alternatives, modifications, and equivalents as can be included within the spirit and scope of the following claims.

What is claimed is:

1. A semiconductor layout design method of designing semiconductor layouts with homogenous levels of wiring density, comprising:
configuring a plurality of dummy terminals (D1, D2, . . . ) for wiring density adjustment on at least one power line (S11).

2. The semiconductor layout design method, according to claim 1, further comprising:
configuring at least one wire that connects one of said plurality of dummy terminals on part of said power line to an other one of said plurality of dummy terminals on distant part of said power line, for wiring density adjustment (S16).

3. The semiconductor layout design method, according to claim 2, further comprising:
configuring at least one wire (F1) running along side a clock line (E1) that connects one of said plurality of dummy terminals on part of said power line to an other one of said plurality of dummy terminals on distant part of said power line.

4. A semiconductor layout design method of designing semiconductor layouts with homogenous levels of wiring density, comprising:
configuring at least one fill cell (100) within an open space left between functional blocks, with said fill cell (100) comprising at least one dummy terminal (J1) on a power line for wiring density adjustment.

5. The semiconductor layout design method, according to claim 4, wherein said at least one dummy terminal (J1) on said power line is configured above a contact (G1) for a diffused layer in said fill cell (100).

6. The semiconductor layout design method, according to claim 4, further comprising:
configuring at least one wire that connects one of said at least one dummy terminal on part of said power line to another one of said at least one dummy terminal on a distant part of said power line, for wiring density adjustment.

7. The semiconductor layout design method, according to claim 1, wherein said configuring of said plurality of dummy terminals (D1, D2, . . . ) comprises:
configuring a plurality of dummy terminals spaced on at least one power line within an area of low-density wiring; and
removing the dummy terminals that overlap signal lines.

8. An apparatus for designing semiconductor layouts with homogenous levels of wiring density, comprising:
configurating means, which configures a plurality of dummy terminals (D1, D2, . . . ) for wiring density adjustment on at least one power line.

9. The apparatus, according to claim 8, further comprising:
second configurating means, which configures at least one wire that connects one of said plurality of dummy terminals on part of said power line to an other one of said plurality of dummy terminals on distant part of said power line, for wiring density adjustment.

10. The apparatus, according to claim 9, further comprising:
third configurating means, which configures at least one wire (F1) running along side a clock line (E1) that connects one of said plurality of dummy terminals on part of said power line to an other one of said plurality of dummy terminals on distant part of said power line.

11. An apparatus for designing semiconductor layouts with homogenous levels of wiring density, comprising:
configurating means, which configures at least one fill cell (100) within an open space left between functional blocks, with said fill cell (100) comprising at least one dummy terminal (J1) on a power line for wiring density adjustment.

12. The apparatus, according to claim 11, wherein said at least one dummy terminal (J1) on said power line is configured above a contact (G1) for a diffused layer in said fill cell (100).

13. The apparatus, according to claim 11, further comprising:
second configurating means, which configures at least one wire that connects one of said at least one dummy terminal on part of said power line to an other one of said at least one dummy terminal on distant part of said power line, for wiring density adjustment.

14. The apparatus, according to claim 8, wherein said configurating means is comprised of
third configurating means, which configures a plurality of dummy terminals spaced on at least one power line within an area of low-density wiring; and
remover that removes the dummy terminals that overlap signal lines.
